(19) United States
(12) Patent Application Publication
(10) Pub. No.: US 2022/0306538 A1
(43) Pub. Date: Sep. 29, 2022

(54) BUILDING LARGE PORCELAIN PANEL

(71) Applicant: SEKISUI HOUSE, LTD., Osaka-shi Osaka (JP)

(72) Inventor: Masato FURUKAWA, Osaka-shi Osaka (JP)

(21) Appl. No.: 17/287,235

(22) PCT Filed: Jun. 23, 2020
(86) PCT No.: PCT/JP2020/024617

§ 371 Date: Apr. 21, 2021

(51) Int. Cl. C04B 33/24; B28B 1/00; E04F 13/14; C04B 33/13

(52) U.S. Cl. CPC C04B 33/24; B28B 1/008; E04F 13/14; C04B 33/131; C04B 2111/60

(57) ABSTRACT

An object of the present invention is to provide a building large porcelain panel that prevents the efflorescence.

As the solutions, a building large porcelain panel according to the present invention is formed by kneading a raw material formulation containing, as a main material, a refractory aggregate, a glassy raw material, and cement, and subjecting the raw material formulation to molding and then firing, wherein the building large porcelain panel has a Na₂O content of 1 mass% or less in an entire chemical-component composition of the building large porcelain panel fired. In addition, the building large porcelain panel has a Na2O content of 1% or less and containing 0.5 to 7% of BaO and 0.5 to 8% of B₂O₃ (12% or less of the BaO and the B₂O₃) at mass-based chemical component values.

### TECHNICAL FIELD

The present invention relates to a large porcelain panel used as a construction interior or exterior material, an exterior, a tunnel interior material, or the like.

### BACKGROUND ART

As a ceramic large panel-shaped building material, a cement unfired panel and a porcelain panel represented by a tile are known. Of these examples, the cement unfired panel has poor structural strength and thus has insufficient durability. Further, coloring performed on a surface of the cement unfired panel is generally resin coating to easily cause discolorment.

In contrast, the porcelain panel has a dense and high-strength structure due to treatment by firing and thus has significantly excellent durability and weather resistance. Further, a surface of the porcelain panel is colored, for example, by glazing or due to color variation during firing, to cause no discolorment problem.

A building large porcelain panel is, for example, as described in Patent Literature 1, manufactured by kneading a raw material formulation containing, as a main material, a refractory raw material, cement, and glass powder, and subjecting the raw material formulation to extrusion molding and then firing.

### CITATION LIST

PATENT LITERATURES

Patent Literature 1: JP 2001-19508 A

Patent Literature 2: JP 05-87466 B

### SUMMARY OF THE INVENTION

TECHNICAL PROBLEMS

The porcelain panel is manufactured through firing, and therefore, a large porcelain panel is easily deformed along with firing shrinkage. The cement used in the manufacturing functions as a binder and has an effect of preventing the firing shrinkage.

On the other hand, the glass powder acts as a sintering agent and has an effect of imparting strength to a sintered porcelain panel. In addition, the glass powder reacts with a cement component such as C₂S or C₃S to produce wollastonite (CaO SiO₂) and anorthite (CaO Al₂O₃ 2SiO ₂) and prevents the firing shrinkage of the porcelain panel by expansion along with the production reaction.

This kind of porcelain panel, however, has a problem of absorbing water such as moisture or rain during use to cause efflorescence. The efflorescence stains a surface of the porcelain panel in white spots and damages appearance required of the building material. In addition, the efflorescence is fixed to a surface structure of the porcelain panel, and removing the efflorescence requires substantial effort.

For example, Patent Literature 2 proposes, as a countermeasure against the efflorescence, adding magnesium silicate, active silica, or aluminum silicate to form a cause of the efflorescence, sodium sulfate into Na₂O nSiO₂ stable with an alkali metal oxide.

The alkali metal oxide and Na₂O nSiO_{2,} however, cannot keep the structures thereof over a long period, and the building material used for a long period cannot give a sufficient effect for the efflorescence prevention. In addition, the production of Na₂O nSiO₂ easily becomes a cause of excessive sintering and thus gives a problem of degrading dimensional accuracy due to firing deformation and making cutting work difficult.

An object of the present invention is to provide a building large porcelain panel that prevents the efflorescence without causing the conventional problems.

SOLUTIONS TO PROBLEMS

A building large porcelain panel according to the present invention is formed by kneading a raw material formulation containing, as a main material, a refractory aggregate, a glassy raw material, and cement, and subjecting the raw material formulation to molding and then firing, the building large porcelain panel being characterized by having a Na₂O content of 1 mass% or less in an entire chemical- component composition of the building large porcelain panel fired. The present invention also provides a building large porcelain panel formed by kneading a raw material formulation containing, as a main material, a refractory aggregate, a glassy raw material, and cement, and subjecting the raw material formulation to molding and then firing, the building large porcelain panel having a Na₂O content of 1% or less and containing 0.5 to 7% of BaO and 0.5 to 8% of B₂O₃ (12% or less of the BaO and the B₂O₃) at mass-based chemical component values.

According to knowledge of the inventors of the present invention, a conventional material allows sulfate of soda to be produced by a reaction of a sulfate radical eluted from a gypsum component of cement with a sodium component from a glass raw material and to be deposited on a surface of the porcelain panel, and this phenomenon causes the efflorescence.

In order to solve this problem, the present invention sets the Na₂O content of the porcelain panel at 1% or less to suppress the production of sulfate of soda causing the efflorescence. The structure formed by reducing the Na₂O content is different from the alkali metal oxide and Na₂O nSiO₂ produced in, for example, the material proposed in Patent Literature 2, and is stable and exhibits an efflorescence prevention effect over a long period that is required of the building material. In addition, the reduction of the Na₂O content produces no Na₂O nSiO₂ causing the excessive sintering observed in the above-described material and causes neither the dimensional accuracy nor the degradation of the cutting work.

Na₂O is mainly contained in the refractory aggregate and the glassy raw material. In the present invention, when the reduction of the Na₂O in the porcelain panel is attained by using low soda glass, the efflorescence prevention becomes more effective. This is because the Na₂O in the refractory aggregate is stable, whereas the Na₂O in the glassy raw material is easily eluted due to an amorphous structure of the glass. Therefore, the use of the low soda glass directly contributes to reduction of the elution of the Na₂O component causing the efflorescence.

The porcelain panel according to the present invention that attains the reduction of the Na₂O content and further contains specific amounts of BaO and B₂O₃ further improves the efflorescence prevention effect and is also excellent in terms of strength.

The addition of the BaO and the B₂O₃ accelerates melting of the glassy raw material during firing for the porcelain panel to cause decomposition of the gypsum component of the cement in a low-temperature range and thus progress decomposition of the sulfate radical causing the efflorescence. In addition, the sulfate radical reacts with the BaO to form structurally stable barium sulfate and thus prevent the elution. The sulfate radical reacts with the BaO to form structurally stable barium sulfate and thus prevent the elution.

In the present invention, a decrease of soda in the porcelain panel makes it difficult for the glassy raw material to be melted in the firing and tends to lower the action of the glassy raw material as the sintering agent. The addition of the BaO and the B₂O_{3,} however, accelerates the melting of the glassy raw material and prevents lowering of the melting of the glassy raw material caused by the decrease of soda. This countermeasure eliminates the problem of the strength of the porcelain panel.

In order to effectively accelerate the melting of the glassy raw material, the BaO and the B₂O₃ are preferably supplied as components contained in the glassy raw material. For this purpose, used as the glassy raw material is, for example, low soda glass having a Na₂O content of 1 mass% or less and containing 2 to 20 mass% of the BaO and 2 to 30 mass% of the B₂O₃ (33 mass% or less of the BaO and the B₂O₃).

### DESCRIPTION OF EMBODIMENTS

In the present invention, the porcelain panel has a Na₂O content of 1 mass% or less, further preferably 0.7 mass% or less. The porcelain panel having a Na₂O content of more than this amount cannot give the efflorescence prevention effect of the present invention.

The glassy raw material used in the present invention is a raw material softened and melted into glass at about 700 to 900° C. Examples of the glassy raw material include soda glass, soda-lime glass, borosilicate glass, alumina silicate glass, borate glass, and phosphate glass. Waste glass of optical glass, heat-resistance glass, window glass, bottle glass, or vehicle glass is preferably used for an economical reason.

The glassy raw material is generally soda glass mainly containing SiO_{2,} CaO, and Na₂O, as represented by, for example, window glass, and containing about 6 to 15 mass% of the Na₂O. In the present invention, the Na₂O content of the porcelain panel is reduced to within the range of the present invention, and therefore low soda glass is preferably used as the glassy raw material.

The low soda glass has a Na₂O content of 1 mass% or less, further preferably 0.5 mass% or less. The low soda glass having a Na₂O content of more than this amount cannot give the efflorescence prevention effect.

The porcelain panel containing BaO and B₂O₃ has proportions of the BaO and the B₂O₃ of 0.5 to 7% and 0.5 to 8%, respectively (12% or less of the BaO and the B₂O₃). The BaO in an amount of less than 0.5% has trouble reacting with sulfuric acid, and therefore the effect brought about by the addition of the BaO becomes insufficient. The BaO in an amount of more than 7% makes it difficult for the glassy raw material to be melted and thus causes the excessive sintering. The B₂O₃ in an amount of less than 0.5% makes it difficult for the glassy raw material to be melted and thus causes insufficient strength of the porcelain panel. The B₂O₃ in an amount of more than 8% causes the excessive sintering. In addition, the BaO and the B₂O₃ in a total amount of more than 12% similarly cause the excessive sintering.

When the supply of the BaO and the B₂O₃ is attained by the glass component, the glass used for the supply is low soda glass having a Na₂O content of 1 mass% or less, further preferably 0.5 mass% or less, and low soda glass further containing 2 to 20 mass% of the BaO and 2 to 30 mass% of the B₂O₃ is used.

The BaO and the B₂O₃ in contents of less than these amounts give an insufficient effect of accelerating the melting of glass not to give a further efflorescence prevention effect. The BaO and the B₂O₃ in contents of more than these amounts cause the excessive sintering and give poor cutting work properties. In addition, also the BaO and the B₂O₃ in a total amount of more than 33 mass% cause the excessive sintering.

When the low soda glass used in the present invention is waste glass, the waste glass sometimes contains a transition metal component such as Ni, Mn, or Co for the purpose of coloring or the like. The waste glass, however, does not impair the effects of the present invention as long as the total amount of the transition metal component is in the range of, for example, 5 mass% or less.

The glassy raw material preferably accounts for 3 to 30 mass% of the raw material formulation. The glassy raw material accounting for less than 3 mass% makes the porcelain panel have insufficient structural strength and gives a poor firing shrinkage prevention effect. The glassy raw material accounting for more than 30 mass% causes the excessive sintering.

Specific examples of the cement include Portland cement, alumina cement, and fly-ash cement. In the present invention, Portland cement is preferable in terms of the economic efficiency, the cure rate, and the like.

The cement accounts for preferably 5 to 40 mass%, further preferably 10 to 30 mass% of the raw material formulation. The cement contained less than this amount makes the porcelain panel have insufficient firing shrinkage prevention. The cement contained more than this amount increases the component that produces the efflorescence. Both the cases are not preferable.

The refractory aggregate is, for example, a silica-alumina refractory raw material such as chamotte, pyrophyllite, clay, silica stone, silica sand, feldspar, brick waste mainly containing these materials, or pottery roof-tile waste. As a fine powder portion, a fine powder refractory raw material, i.e., silica flour, calcined alumina, fly ash, or the like may be used. In addition, a lightweight aggregate such as shirasu balloon, Kohga stone, or pearlite may be used in combination.

These refractory aggregates contain Na₂O as a minor component, and it is therefore necessary to adjust the use amount of the refractory aggregate to make the Na₂O content in the entire structure of the porcelain panel fall within the range specified in the present invention.

The refractory aggregate accounts for the remaining portion of the percentage composition, except for the proportions of the glassy raw material and the cement, and has a proportion of, for example, 40 to 80 mass%.

In order to improve impact resistance, an inorganic fiber may further be added. Specific examples of the inorganic fiber include ceramic fibers such as a silica fiber, an alumina fiber, an alumina-silica fiber, and a glass fiber, and mineral fibers such as rock wool, asbestos, and sepiolite. The amount of the inorganic fiber additionally added to 100 mass% of the raw material formulation is preferably 4 mass% or less.

In the manufacturing of the porcelain panel according to the present invention, about 0.3 to 2 mass% of a binder and about 10 to 25 mass% of water are additionally added to 100 mass% of the raw material formulation, the mixture is kneaded and subsequently subjected to molding, curing, and drying, then to glazing as necessary for the purpose of coloring, and to firing by a roller hearth kiln or the like.

The type of the binder is, for example, a synthetic or natural binder such as CMC (carboxymethyl cellulose), MC (methyl cellulose), PVA (polyvinyl alcohol), dextrin, or starch. The molding method is, for example, pressure molding or extrusion molding. The firing temperature is preferably 1000 to 1200° C.

### Examples

Hereinafter, examples of the present invention and comparative examples thereof are described. Table 1 shows the chemical component value of the glassy raw material used in each of the examples. Tables 2 and 3 show the composition of the raw material formulation for the porcelain panel and the test results in each of the examples. Reference signs A to G of the glassy raw materials in Table 1 correspond to the reference signs of the glassy raw material shown in Table 2.

TABLE 1

| | Chemical component value (mass %) | | | | | | | |
|---|---|---|---|---|---|---|---|---|
| | SiO₂ | Al₂O₃ | CaO | MgO | Na₂O | B₂O₃ | BaO | Others |
| Glass A | 60.3 | 7.9 | 18.3 | 7 | 0.9 | 1.5 | 1.9 | 2.2 |
| Glass B | 59.6 | 9.3 | 17.4 | 8.3 | 0.5 | 1.8 | 1.6 | 1.5 |
| Glass C | 57.8 | 15.4 | 6.4 | 2.7 | 0.2 | 5.2 | 8.8 | 3.5 |
| Glass D | 66.6 | 10.7 | 4.7 | 1.2 | 0.1 | 12.3 | 2.3 | 2.1 |
| Glass E | 56 | 15.4 | 5.5 | 1.4 | 0.2 | 2.1 | 17.7 | 1.7 |
| Glass F | 71.1 | 3.5 | 10.6 | 0.9 | 12.2 | | | 1.7 |
| Glass G | 60.4 | 6 | 13.4 | 2.6 | 6.5 | 5.2 | 4.1 | 1.8 |

TABLE 2

| | | | | | Example of present invention | | | | | | | |
|---|---|---|---|---|---|---|---|---|---|---|---|---|
| | | | | | 1 | 2 | 3 | 4 | 5 | 6 | 7 | 8 |
| Raw material | Pyrophyllite (Na₂O: 0.3%) 0.5 mm or less | | | | 30 | 15 | 30 | 30 | 30 | 30 | 30 | 30 |
| formulation | Chamotte (Na₂O: 0.5%) 0.5 mm or less | | | | 35 | 30 | 20 | 35 | 20 | 20 | 20 | 20 |
| (mass %) | Glass A 0.15 mm or less | | | | 5 | 25 | | | | | | |
| | Glass B 0.15 mm or less | | | | | | 20 | | | | | |
| | Glass C 0.15 mm or less | | | | | | | 5 | 15 | 20 | | |
| | Glass D 0.15 mm or less | | | | | | | | | | 20 | |
| | Glass E 0.15 mm or less | | | | | | | | | | | 20 |
| | Normal Portland cement | | | | 30 | 30 | 30 | 30 | 35 | 30 | 30 | 30 |
| Composition of fired | | | Na₂O content (mass %) | | 0.31 | 0.42 | 0.29 | 0.28 | 0.22 | 0.23 | 0.21 | 0.23 |
| porcelain panel | | | B₂O₃ content (mass %) | | 0.08 | 0.38 | 0.36 | 0.26 | 0.78 | 1.04 | 2.46 | 0.42 |
| (chemical component value) | | | BaO content (mass %) | | 0.08 | 0.48 | 0.32 | 0.44 | 1.32 | 1.76 | 0.46 | 3.54 |
| Test | Efflorescence | Degree of | | Water temperature | None | None | None | None | None | None | None | None |
| | | efflorescence | | 5° C. | | | | | | | | |
| | | (visual inspection) | | Water temperature | None | None | None | None | None | None | None | None |
| | | | | 35° C. | | | | | | | | |
| | | Elution | Sodium | Water temperature | 0.02 | 0.02 | 0.01 | 0.01 | 0 | 0 | 0 | 0 |
| | | (mass %) | content | 5° C. | | | | | | | | |
| | | | | Water temperature | 0.03 | 0.03 | 0.01 | 0.01 | 0.01 | 0 | 0 | 0 |
| | | | | 35° C. | | | | | | | | |
| | | | Sulfate | Water temperature | 0.17 | 0.13 | 0.13 | 0.12 | 0.05 | 0.04 | 0.05 | 0.04 |
| | | | radical | 5° C. | | | | | | | | |
| | | | | Water temperature | 0.18 | 0.16 | 0.15 | 0.15 | 0.06 | 0.04 | 0.07 | 0.05 |
| | | | | 35° C. | | | | | | | | |

| | | | | | | | | |
|---|---|---|---|---|---|---|---|---|
| Dimensional accuracy (linear change: %) | 0 | 0.3 | 0.2 | 0.2 | 0.2 | 0.2 | 0.4 | 0.3 |

TABLE 3

| | | | | | Comparative Example | | |
|---|---|---|---|---|---|---|---|
| | | | | | 1 | 2 | 3 |
| Raw material | Pyrophyllite (Na₂O: 0.3%) 0.5 mm or less | | | | 20 | 15 | 25 |
| formulation | Chamotte (Na₂O: 0.5%) 0.5 mm or less | | | | 35 | 30 | 20 |
| (mass %) | Chamotte F 0.5 mm or less | | | | 15 | | 15 |
| | Chamotte G 0.5 mm or less | | | | | 25 | |
| | Normal Portland cement | | | | 30 | 30 | 25 |
| | Serpentinite | | | | | | 15 |
| Composition of fired | | | Na₂O content (mass %) | | 2.07 | 1.82 | - |
| porcelain panel | | | B₂O₃ content (mass %) | | 0.00 | 1.30 | - |
| (chemical component value) | | | BaO content (mass %) | | 0.00 | 1.03 | - |
| Test | Efflorescence | Degree of efflorescence | | Water temperature 5° C. | Severe | Moderate | Slight |
| | | (visual inspection) | | Water temperature 35° C. | Severe | Severe | Moderate |
| | | Elution | Sodium | Water temperature 5° C. | 0.19 | 0.25 | - |
| | | (mass %) | content | Water temperature 35° C. | 0.22 | 0.27 | - |
| | | | Sulfate | Water temperature 5° C. | 0.3 | 0.22 | - |
| | | | radical | Water temperature 35° C. | 0.35 | 0.25 | - |

| | | | |
|---|---|---|---|
| Dimensional accuracy (linear change: %) | 0 | 0.3 | - |

Hyphen “-” in test results represents no measurement.

In each of the examples, 1 mass% of MC (methyl cellulose) as a binder and 20 mass% of water were additionally added to the raw material formulation shown in the table, the mixture was kneaded and molded by an extruder into a product having a dimension of 20 mm (thickness) ×300 mm (width) ×2000 mm (length). Subsequently, the product was fired by a roller hearth kiln at 1100° C. for 3 hours to give a building large porcelain panel. The test methods are as follows.

Efflorescence test: a test piece obtained by cutting the building large porcelain panel into a dimension of 300 mm ×300 mm was immersed in water at water temperatures of 5° C. and 35° C. respectively for 48 hours under the assumption of seasonal changes. Then, the test piece was evaluated for appearance by visual inspection and measured for the elution amounts of the sodium content and the sulfate radical.

In the test for appearance by visual inspection, only a lower half portion of the test piece was immersed in water, and the state of efflorescence generated in an upper half portion not immersed in water was observed.

The elution amount of the sodium content was measured by immersing the entire test piece in water and measuring by an ion meter the amount of the sodium content eluted into water. The elution of the sulfate radical was measured by a precipitation gravimetric method using barium chloride. The efflorescence is more easily caused according as the elution amount of each of the components increases.

Dimensional accuracy test: the linear change along with firing shrinkage was measured from the dimension between before and after the firing. The firing shrinkage is larger according as the linear change increases.

As shown by the test results of the table, all the porcelain panel materials obtained in the examples of the present invention have an excellent efflorescence prevention effect and also have excellent dimensional accuracy. Among the examples, Examples 5 to 8 are materials containing the BaO and the B₂O₃ within the range of the present invention and thus have a further excellent efflorescence prevention effect.

In contrast, Comparative Example 1 corresponds to a conventional material, has a Na₂O content of more than the range specified in the present invention, and thus cannot give the efflorescence prevention effect. Comparative Example 2 has a BaO content and a B₂O₃ content within the range of the present invention but has a Na₂O content of more than the range specified in the present invention, and thus cannot give the efflorescence prevention effect.

In Comparative Example 3, the efflorescence was attempted by adding a magnesium silicate mineral, or serpentinite. Comparative Example 3, however, gives an insufficient efflorescence prevention effect.

(Effects of the invention)

The efflorescence badly damages the appearance required of the construction material. The present invention resolves the problem of the efflorescence, and the effect thereof is clear as shown by the test results of the examples. In addition, the dimensional accuracy is also satisfying. These results enable the construction large porcelain panel to exhibit every effect of durability and weather resistance.

1. A building large porcelain panel formed by kneading a raw material formulation containing, as a main material, a refractory aggregate, a glassy raw material, and cement, and subjecting the raw material formulation to molding and then firing, the building large porcelain panel having a Na₂O content of 1% or less at a mass- based chemical component value.

2. The building large porcelain panel according to claim 1, having a Na₂O content of 1% or less, and containing 0.5 to 7% of BaO and 0.5 to 8% of B₂O₃ but 12% or less of the BaO and the B₂O₃ at mass-based chemical component values.

3. The building large porcelain panel according to claim 2, wherein the glassy raw material accounts for 3 to 30% of the raw material formulation.

4. The building large porcelain panel according to claim 3, wherein the glassy raw material is low soda glass having a Na₂O content of 1% or less at a mass-based chemical component value.

5. The building large porcelain panel according to claim 4, wherein the glassy raw material is the low soda glass having a Na₂O content of 1% or less, and containing 2 to 20% of the BaO and 2 to 30% of the B₂O₃ but 33% or less of the BaO and the B₂O3 at mass-based chemical component values.

6. The building large porcelain panel according to claim 5, wherein a firing temperature is 1000 to 1200° C.
